(19) United States
(12) Patent Application Publication
(10) Pub. No.: US 2018/0150788 A1
(43) Pub. Date: May 31, 2018

(54) INVENTORY CONTROL SYSTEM AND A METHOD FOR INVENTORY CONTROL IN AN ESTABLISHMENT

(71) Applicant: Wipro Limited, Bangalore (IN)

(72) Inventors: Navya VEPAKOMMA, Bangalore (IN); Suyog Trivedi, Indore (IN)

(73) Assignee: Wipro Limited

(21) Appl. No.: 15/413,543

(22) Filed: Jan. 24, 2017

(30) Foreign Application Priority Data
Nov. 30, 2016 (IN) 201641040992

(51) Int. Cl. G06Q 10/08; G06K 9/46; G06K 9/40; G06K 9/32

(52) U.S. Cl. CPC G06Q 10/087; G06K 9/3233; G06K 9/40; G06K 9/4604

(57) ABSTRACT

Systems and methods for inventory control in an establishment are described. The system receives sensor data, planogram data, and image data. Based on the sensor data, the system determines current position of products placed at product support devices (PSD). Further, the current position is compared with predefined arrangement defined in the planogram data. Further, the system determines planogram compliance metric, based on the comparison, indicating deviation of placement of the products. The system further identifies the products in the PSDs based on the image data. Further, a product-count corresponding to each of the products are determined. The product-count of at least one product is compared with corresponding predefined threshold count to determine a product stock-out condition indicating at least one of an out of stock condition and low on stock condition. The system further generates product filling information based on the product stock-out condition.

### TECHNICAL FIELD

The present disclosure relates in general to inventory control. More particularly, but not exclusively, the present disclosure discloses a system and method for inventory control in an establishment.

### BACKGROUND

Inventory management is a process of ensuring adequate supply of products or goods to meet customer's demand. For having a robust inventory management, lots of human effort is required. For example, store manager must keep his/her eyes all around the clock in retail store to maintain the stock. The job of the store manager is not only limited to stock management, but he/she also must comply with planogram requirement. As conventionally known, the planogram is a diagram or predefined layout that shows how and where specific retail products should be placed on retail shelves or displays (i.e., products support devices) in order to increase customer purchases. Along with this dual job, the next important responsibility of the retail manager is to re-fill the products which are completely out of stock or approaching toward complete stock-out condition.

The above discussed jobs and responsibility not only requires alertness of the store manager, but at the same time accuracy and speed is also expected. With the advent of technology, attempts have been made to meet the above challenges. However, there are some technical challenges which still needs to be addressed. For example, one of technical challenge is that available inventory management systems need to be first trained the with pre-captured images samples of products so that at the time of implementation, the products, and their counts i.e., stock could be easily determined. Even upon training, the next technical challenge arises when new products are introduced. This is because, the inventory management systems now will not be able to recognize the newly introduced products, since it is not trained with the new product samples. Thus, it will fail to recognize the stock-out situation of those new products. Thus, providing training to inventory management systems not only increases the dependency, but also increases the unnecessary load on internal resources (e.g., processor, memory, bandwidth) of such system. The unnecessary load further affects not only the performance but also the accuracy of the system.

### SUMMARY

Disclosed herein is a method and system for inventory control in an establishment. The establishment comprises number of product support devices on which products are placed. The placement of the products is strategic i.e., based on planogram data. When the products are misplaced from its original location (defined as per the planogram data), it is called as planogram incompliance. The misplacement of the products may also lead to false product stock-out condition. However, the actual product stock-out condition may happen when quantity of products significantly decreases than a threshold. Thus, to deal with the issues of planogram incompliance and product stock-out condition, the present disclosure provides various methodologies discussed in upcoming paragraphs of the specification. Apart from addressing these issues, the present disclosure also determines product filling information which provides actual count of the products, to be filled in the product support devices, approaching towards, or already reached to the stock-out condition. Further, the present disclosure overcomes technical challenge of providing training to system before implementation. Thus, the system disclosed in the present disclosure is independent of any training mechanism.

Accordingly, the present disclosure relates to a method for inventory control in an establishment. The method comprises the step of receiving sensor data associated with a plurality of products and planogram data associated with the establishment. The sensor data provides depth-information of the plurality of products placed on product support devices in the establishment supporting the plurality of products. Further, the planogram data comprises dimensions and predefined arrangement of the plurality of products placed on the product support devices. The method further comprises determining current position of the plurality of products based on the sensor data. Further, the method comprises comparing the current position of the plurality of products with the predefined arrangement as defined in the planogram data. The method further comprises determining a planogram compliance metric for inventory control based on the comparison. The planogram compliance metric indicates a deviation of placement of the plurality of products from the predefined arrangement.

Further, the present disclosure relates to an inventory control system for inventory control in an establishment. The inventory control system comprises a processor and a memory communicatively coupled to the processor. The memory stores processor-executable instructions, which, on execution, causes the processor to perform one or more operations comprising receiving sensor data associated with a plurality of products and planogram data associated with the establishment. The sensor data provides depth-information of the plurality of products placed on product support devices in the establishment supporting the plurality of products. Further, the planogram data comprises dimensions and predefined arrangement of the plurality of products placed on the product support devices. The system further determines current position of the plurality of products based on the sensor data. Further, the system compares the current position of the plurality of products with the predefined arrangement as defined in the planogram data. Further, the system determines a planogram compliance metric for inventory control based on the comparison. The planogram compliance metric indicates a deviation of placement of the plurality of products from the predefined arrangement.

Furthermore, the present disclosure relates to a non-transitory computer readable medium including instructions stored thereon that when processed by at least one processor cause an inventory control system to perform the acts of receiving sensor data associated with a plurality of products and planogram data associated with the establishment. The sensor data provides depth-information of the plurality of products placed on product support devices in the establishment supporting the plurality of products. Further, the planogram data comprises dimensions and predefined arrangement of the plurality of products placed on the product support devices. The inventory control system further determines current position of the plurality of products based on the sensor data. Further, the inventory control system compares the current position of the plurality of products with the predefined arrangement as defined in the planogram data. Further, the inventory control system determines a planogram compliance metric for inventory control based on the comparison. The planogram compliance metric indicates a deviation of placement of the plurality of products from the predefined arrangement.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 shows an exemplary environment illustrating an inventory control system for inventory control in an establishment in accordance with some embodiments of the present disclosure;

FIG. 2 shows a detailed block diagram illustrating the inventory control system in accordance with some embodiments of the present disclosure;

FIG. 3 shows a flowchart illustrating a method for inventory control in an establishment in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and an inventory control system (alternatively also referred as “system”) for inventory control in an establishment. Although, the method for inventory control system is described in conjunction with a server, the said method can also be implemented in various computing systems/devices, other than the server. The establishment like retail stores comprises number of product support devices, for example shelves, racks, display stands, and aisle endcap displays that holds the products in the establishment. The primary objective of placing the products on the product support devices is to provide easy and comfortable shopping experience to customers.

The placement of the products is not random, but it is strategically planned. The planning is based on planogram base or planogram data which defines the arrangement or placement of the products on the shelves based on various factors like size, cost, shape, and the like. However, many a times it has been observed that customers misplace the products from its original location. This happens when the customers pick the products in his/her cart/basket from its original location, and later decide not to purchase that picked up product and places that product somewhere else. This leads to planogram incompliance situation. Thus, the misplacement of the products from its original location leads to a problem.

One of an objective of the present disclosure is to provide a solution to the problem by using various inputs and technical measure. For example, the system receives the planogram data as an input quite before implementing the solution. The planogram data not only helps the system understand the plot or map of the establishment, but it may also help the system to realize the original position of the products placed on the product support devices. Apart from the planogram data, the system may also receive sensor data related to the products and image data related to the product support devices. In the present disclosure, the sensor data and the image data are received and analyzed in real-time. Therefore, there is no requirement providing training to the system to sample images of products or product support devices.

Based on the above received data i.e., the planogram data, the sensor data and the image data, the system determines planogram incompliance and product stock-out condition. The planogram incompliance indicates that the product has been misplaced from its original location, whereas the product stock-out condition indicates that the product is either approaching or has already reached to a stock-out condition. In case of the stock-out condition is detected, the system also provides refilling information for refilling the products back to the product support devices. Each of the abovementioned features of present disclosure is explained in detail in subsequent paragraphs of the specification.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

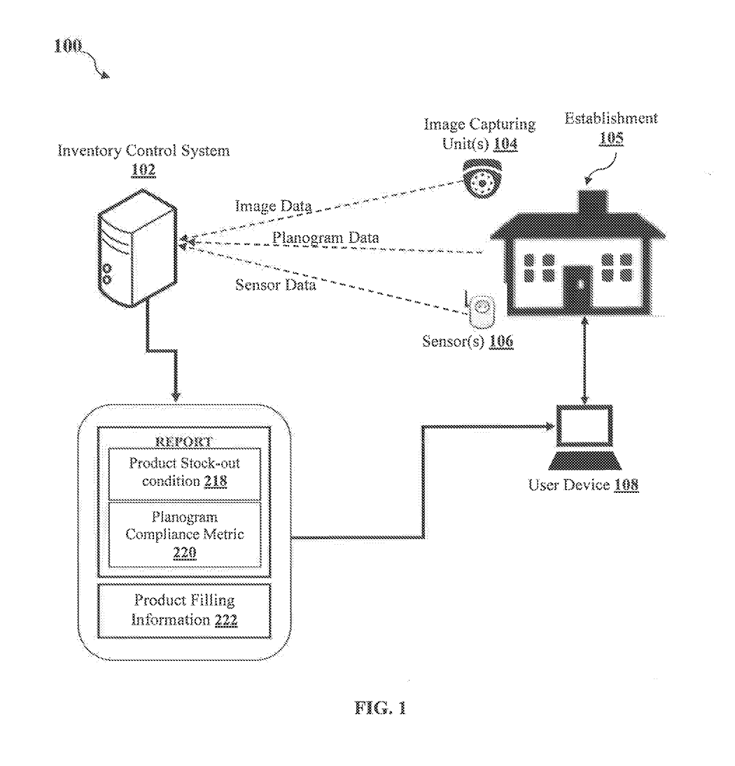

FIG. 1 shows an exemplary) environment illustrating an inventory control system for inventory control in an establishment.

The environment 100 may comprise an establishment 105 having image capturing unit(s) 104, sensor(s) 106 and a user device 108 connected therewith. The environment 100 may also comprise the inventory control system 102 which receives data such as planogram data associated with the establishment 105, image data captured by the image capturing unit(s) 104, and sensor data associated with plurality of products in the establishment 105 captured by the sensor(s) 106. The planogram data may comprise dimensions and predefined arrangement of the plurality of products placed on product support devices (PSD) in the establishment 105. The sensor data may provide depth-information of the plurality of products placed on the product support devices. The image data may comprise one or more images of the PSDs.

The data (i.e., planogram data, image data and sensor data) is processed by the inventory control system 102 to determine the planogram compliance metric 220 and the product stock-out condition 218. Post determining the product stock-out condition 218, the inventory control system 102 may also determine the product filling/refilling information 222 providing an appropriate count of the product to be filled back in the product support devices of the establishment 105. In an embodiment, the inventory control system 102 may include, but not limited to, a server, a computer, a workstation, a laptop, mobile phone, or any computing system/device capable of receiving, analysing and processing the useful information. Also, the user device 108 may include computing devices likes computer, laptop, or mobile device.

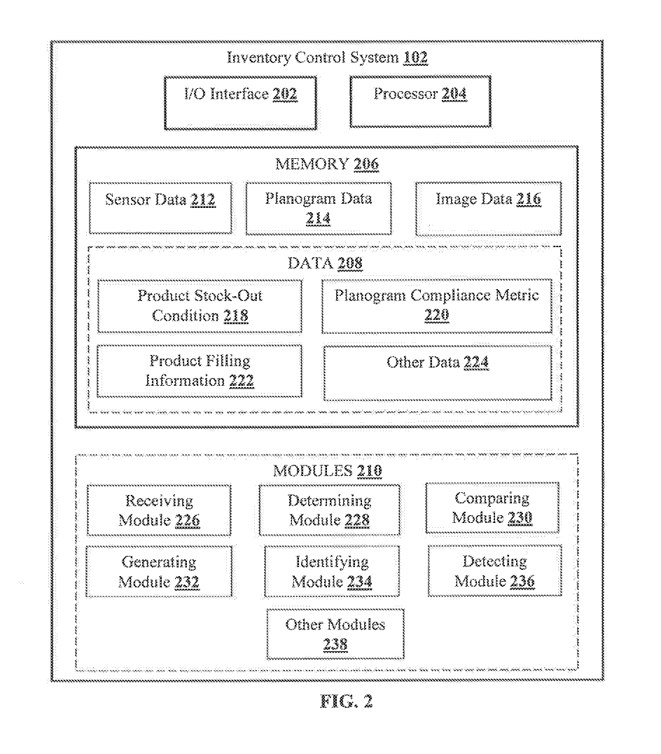

FIG. 2 shows a detailed block diagram illustrating the inventory control system in accordance with some embodiments of the present disclosure.

The inventory control system 102 comprises an I/O interface 202, a processor 204 and a memory 206. The memory 206 is communicatively coupled to the processor 204. The processor 204 is configured to perform one or more functions of the inventory control system 102 for the inventory control in the establishment 105. In one implementation, the inventory control system 102 comprises data 208 and modules 210 for performing various operations in accordance with the embodiments of the present disclosure. The memory 206 further comprises sensor data 212, planogram data 214, and image data 216. In an embodiment, the data 208 may include, without limitation, a product stock-out condition 218, planogram compliance metric 220, product refilling information 222, and other data 224.

In one embodiment, the data 208 may be stored within the memory 206 in the form of various data structures. Additionally, the aforementioned data 208 can be organized using data models, such as relational or hierarchical data models. The other data 224 may store data, including temporary data and temporary files, generated by modules 210 for performing the various functions of the inventory control system 102.

In an embodiment, the data 208 may be processed by one or more modules 210. In one implementation, the one or more modules 210 may also be stored as a part of the processor 204. In an example, the one or more modules 210 may be communicatively coupled to the processor 204 for performing one or more functions of the inventory control system 102.

In one implementation, the one or more modules 210 may include, without limitation, a receiving module 226, a determining module 228, a comparing module 230, a generating module 232, an identifying module 234, a detecting module 236, and other modules 238. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the receiving module 226 may receive sensor data 212 associated with a plurality of products, planogram data 214 associated with the establishment 105, and image data 216 associated with the product support devices present in the establishment 105. The sensor data 212 provides depth-information of the plurality of products placed on the product support devices in the establishment 105. The sensor data 212 may be provided by one or more sensors 106 (e.g. Ultrasonic sensors, Infrared sensors, and Thermal sensors) placed at/around the product support devices of the establishment 105. These sensors 106 may provide data points related to depth or distance from concerned products. For example, the sensors 106 may transmit infra-red rays and the time taken for the ray to reflect to a receiver (of the sensor) is calculated. The larger the time taken, the farther away is the product from the sensor 106. This way, the depth-information of the plurality of products may be determined. The depth-information eliminates a requirement for providing any training to the system 102 with sample images of products for product identification.

The selection of the sensors 106 may depend on environmental conditions around the PSDs. This is because, the environmental conditions like lighting conditions or exposure to sun light may have positive and negative effects on the sensor data points. According to embodiments, the sensors 106 may be attached at back end of the PSDs and may be configured based on features/specification of the product support devices (PSDs). The dependency of the sensors 106 on the PSDs are explained as:

Range_{Sensors}=f(PSD(Depth))

The sensor data 212 captured may be associated with a time frame which is used for synchronization with image data 216, which is explained in upcoming paragraphs of the specification.

On the other hand, the planogram data 214 comprises dimensions and predefined arrangement of the plurality of products placed on the PSDs. According to embodiments, the planogram data 214 may be present in different formats, for example an image format (JPEG, PNG, etc.) or as a tabulated comma separated file (CSV) or located in Microsoft™ Access database. The planogram data 214 is a layout design defining the arrangement of each of the plurality of products on the PSD. The arrangement comprises predefined positions at which the plurality of products are to be placed on the PSDs. For example, exact position or location is defined (i.e., aisle, product support device number, row number and product position on the row) for each of the plurality of products along with the dimensions of the product. The planogram data 214 may also provide other information, for example how many products are to be stacked vertically, horizontally and one behind the other. Since the product arrangement defined in the planogram data 214 must be strictly followed, it plays vital role while determining the planogram incompliance.

Further, the image data 216 may comprise one or more images of the product support devices (PSDs) and may be provided by image capturing units 104 like cameras. According to embodiments, the image capturing units 104 are placed in front of the PSDs for capturing the images of the products. Also, the image capturing units 104 may be configured based on the PSDs and other factors like length of the PSDs, width of the PSDs, height and width of the plurality of products. The dependency of the image capturing units 104 on the PSDs are explained as:

Angle of View(AOV)_{Image Capturing Unit}=f(PSD(helght),PSD(width))

Further, the placement of the image capturing units 104 are such that all the products placed on the PSDs may be captured. Also, the image capturing units 104 captures the image data 216 in real-time and transmits them to the inventory control system 102.

Once the sensor data 212, planogram data 214 and image data 216 are received, the inventory control system 102 may perform data formatting and cleansing. For example, the planogram data 214 received in an image format may be converted by the inventory control system 102 into readable tabulated data. Further, the image data 216 obtained from the image capturing units 104 are sorted as per their input time. Further, the sensor data 212 is also collected and is linked with the image data 216 keeping the time frame information associated with both the image data and the sensor data 212. Now during the data cleansing, unwanted signals, and unwanted data points, present in the image data 216 and the sensor data 212 may be removed. These unwanted signals may be like noise due to lighting, occlusion in front of the image capturing units 104, reflection of light on the products placed on the PSDs or false data points received by the sensors due 104 to reflection of sensor signals from the PSDs.

After formatting and cleansing the data (sensor data, planogram data and image data), the next step is to determine the planogram incompliance and stock-out situation of the products placed at the PSDs. For this, the determining module 228 of the inventory control system 102 may determine the current position of the plurality of products using the depth-information provided in the sensor data 212. The current position indicates a location where the product is currently found which may be different from the location defined in the planogram data 214.

Once the current position is located, the comparing module 230 of the inventory control system 102 compares the current position of the plurality of products with the predefined arrangement as defined in the planogram data 214. The predefined arrangement is the predefined position of the plurality of products expected to be placed on the PSDs. During the comparison, if the products are found at their expected locations or positions, then it is determined that the planogram compliance is met. However, if the products are not found at their expected locations or positions, inventory control system 102 consider it as planogram incompliance. Thus, based on the comparison, the determining module 228 of the inventory control system 102 may determine a planogram compliance metric 220. The planogram compliance metric 220 indicates a deviation of placement of the plurality of products from the predefined arrangement.

Further, the generating module 232 of the inventory control system 102 may generate planogram incompliance alert when the planogram compliance metric 220 is detected. The generating module 232 may also generate a report (as shown in FIG. 1) depicting the planogram compliance metric 220. The generated report may be transmitted to the user device 108 which may be a device of retail store manager, inventory control manager, store manager and the like. This way the retail store manager/inventory control manager/store manager is intimated to take appropriate/corrective actions regarding the product replenishment or product position correction in order to meet the planogram compliance. The report may be generated in a form of a dashboard in order to provide consolidated view to retail store manager/inventory control manager/store manager at regular time interval. According to embodiments, the report generated may be transmitted to the user device 108 via different wireless means like electronic mail (e-mail) or short messaging service (SMS).

Apart from determining the planogram incompliance, another objective of the inventory control system 102 is to determine stock-out situation of the products placed at the PSDs to avoid product shortage. For this, the identifying module 234 of the inventory control system 102 identifies the plurality of products, placed at the PSDs, based on the image data 216. As discussed in above paragraphs, the image data 216 is received by the receiving module 226 of the inventory control system 102. Like the sensor data 212, the image data 216 may also contain the unwanted signals/noise data which is to be removed for identifying the plurality of products. Thus, in first step, the generating module 232 of the inventory control system 102 generates a clean image data by removing the noise data (i.e., blur data and unwanted signals) from the image data 216 using electronic filters. Any image of the image data 216 having a noise level (i.e., the noise data) above a predefined threshold (for example, if 50% of the image is occluded and PSD is not visible), then the image is discarded and may not be evaluated. The noise levels in an image may be measured as:

Noise_{image}=f(High frequency Components_{window-wise},Key features_{products})

Now once the clean image data is generated, in the next step, the identifying module 234 may identify a region of interest (ROI) in the clean image data. According to the embodiments, the ROI corresponds to the PSDs. Since, the plurality of products is placed on the PSDs, it is important to figure out the PSDs first from the clean image. From the identified ROI, the detecting module 236 may detect one or more rows associated with the PSDs by using line and color detection technique. The one or more rows are the actual location where the products are placed. Hence, the determination of PSDs and then the one or more rows of the PSDs helps the inventory control system 102 to identify individual products placed at each row of the PSDs. Thus, in the next step, the detecting module 236 may detect horizontally stacked and vertically stacked products, of the plurality of products, placed on the one or more rows using horizontal line detection technique and vertical line detection technique respectively. Further, each of the plurality of products detected has their corresponding dimensions and positions. Now, based on the dimensions and positions, the identifying module 234 of the inventory control system 102 may identify the individual products of the plurality of products placed at the PSDs.

The identification of the individual products now helps the inventory control system 102 to determine quantity of each of the plurality of products. Thus, to determine the actual quantity, the determining module 228 may determine a product-count corresponding to each of the plurality of products identified. Once the product-count is determined, determining module 228 of the inventory control system 102 may now determine product stock-out condition 218 for at least one of the plurality of products by comparing the product-count of at least one of the plurality of products with a corresponding predefined threshold count. According to embodiments, the product stock-out condition 218 indicates at least one of an out of stock condition and low on stock condition. Suppose a PSD has multiple products in beverages category (for example, Pepsi™, Coca-Cola™, Miranda™) placed on it in different sizes (300 ML, 1 Liter, 2 Liter). Now at any particular time, when the retail manager wants to know the current stock situation in the PSD, he/she may implement the inventory control system 102. Upon implementation, the system may generate a result that count of “Pepsi™ 1 liter bottle” has come below a predefine threshold count. The result (i.e., product stock-out situation) is generated as stock-out alert and sent to user device 108 of the retail manager. Thus, upon receiving stock-out alert, the retailer manager may immediately take a corrective action to address the deficiency of the products.

Further, according to embodiments, the inventory control system 102 not only let the retail manager be aware about the stock-out situation, but it also assists in filling the products back into the PSDs. For this, the determining module 228 of the inventory control system 102 may use the sensor data 212 and the image data 216 to determine a remaining space in the PSDs. After determining the remaining space, the generating module 232 may generate product filling information 222 for the PSDs based on the product stock-out condition 218. The product filling information 222 provides a filling-count of the at least one product to be filled in the PSDs. This way, the inventory control system 102 facilitates the retail managers/inventory manager to properly control the inventory.

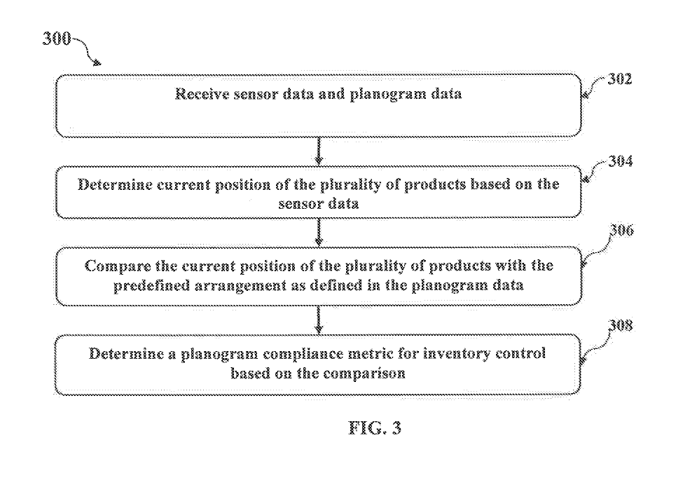

FIG. 3 shows a flowchart illustrating a method for inventory control in an establishment in accordance with some embodiments of the present disclosure.

As illustrated in FIG. 3, the method 300 comprises one or more blocks for inventory control in the establishment 105 by using an inventory control system 102. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 302, the inventory control system 102 may receive sensor data 212 associated with a plurality of products and planogram data 214 associated with the establishment 105. The sensor data 212 may provide depth-information of the plurality of products placed on product support devices in the establishment 105 supporting the plurality of products. Further, the planogram data 214 may comprise dimensions and predefined arrangement of the plurality of products placed on the product support devices.

At block 304, the inventory control system 102 may determine current position of the plurality of products based on the sensor data 212.

At block 306, the inventory control system 102 may compare the current position of the plurality of products with the predefined arrangement as defined in the planogram data 214. The predefined arrangement may comprise predefined position of the plurality of products on the product support devices.

At block 308, the inventory control system 102 may determine a planogram compliance metric 220 for inventory control based on the comparison. The planogram compliance metric 220 may indicate a deviation of placement of the plurality of products from the predefined arrangement.

### Computer System

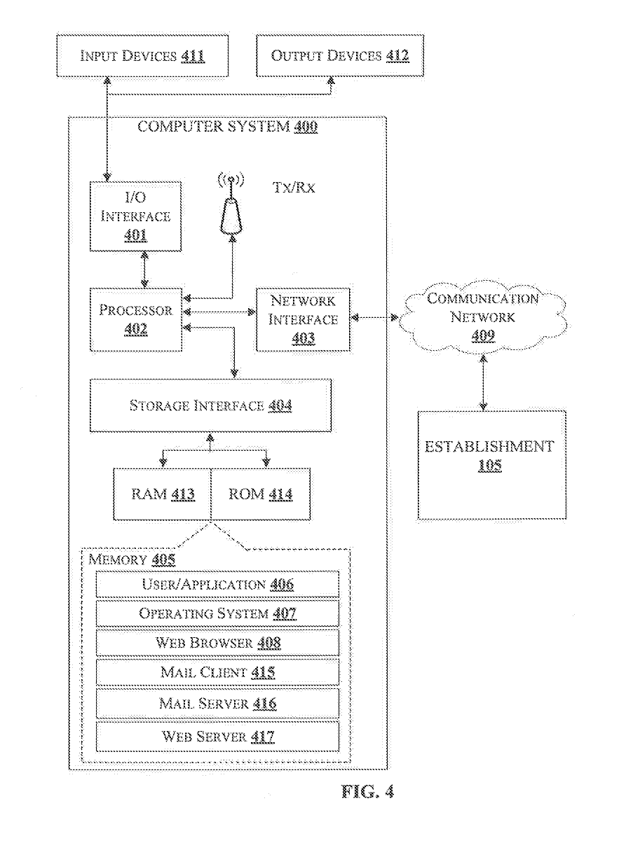

FIG. 4 illustrates a block diagram of an exemplary computer system 400 for implementing embodiments consistent with the present invention. In an embodiment, the computer system 400 can be the inventory control system 102 which is used for inventory control in an establishment. The data such as sensor data 212, planogram data 214, and image data 216 may be received by the computer system 400 from the establishment 105. The computer system 400 may comprise a central processing unit (“CPU” or “processor”) 402. The processor 402 may comprise at least one data processor for executing program components for executing user- or system-generated business processes. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application data 406, an operating system 407, web browser 408 etc. In some embodiments, computer system 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. I/O interface 401 may facilitate display, execution, interaction, manipulation, or operation of program components through textual or graphical facilities. For example, I/O interface may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the Embodiment of the Present Disclosure are Illustrated Herein.

In an embodiment, the present disclosure provides a method for providing an efficient inventory control system.

In an embodiment, the method of present disclosure provides the inventory control system independent of any training for determining products.

In an embodiment, the present disclosure provides a method for optimizing the system's performance while facilitating inventory control.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | ENVIRONMENT |
| 102 | INVENTORY CONTROL SYSTEM |
| 104 | IMAGE CAPTURING UNIT(S) |
| 105 | ESTABLISHMENT |
| 106 | SENSOR(S) |
| 108 | USER DEVICE |
| 202 | I/O INTERFACE |
| 204 | PROCESSOR |
| 206 | MEMORY |
| 208 | DATA |
| 210 | MODULES |
| 212 | SENSOR DATA |
| 214 | PLANOGRAM DATA |
| 216 | IMAGE DATA |
| 218 | PRODUCT STOCK-OUT CONDITION |
| 220 | PLANOGRAM COMPLIANCE METRIC |
| 222 | PRODUCT FILLING INFORMATION |
| 224 | OTHER DATA |
| 226 | RECEIVING MODULE |
| 228 | DETERMINING MODULE |
| 230 | COMPARING MODULE |
| 232 | GENERATING MODULE |
| 234 | IDENTIFYING MODULE |
| 236 | DETECTING MODULE |
| 238 | OTHER MODULES |

1. A method for inventory control in an establishment, the method comprising:
receiving, by an inventory control system, sensor data associated with a plurality of products and planogram data associated with the establishment, wherein:
the sensor data provides depth-information of the plurality of products placed on product support devices in the establishment supporting the plurality of products, and
the planogram data comprises dimensions and predefined arrangement of the plurality of products placed on the product support devices;
determining, by the inventory control system, current position of the plurality of products based on the sensor data;
comparing, by the inventory control system, the current position of the plurality of products with the predefined arrangement as defined in the planogram data; and
determining, by the inventory control system, a planogram compliance metric for inventory control based on the comparison, wherein the planogram compliance metric indicates a deviation of placement of the plurality of products from the predefined arrangement.

2. The method as claimed in claim 1, further comprising generating, by the inventory control system, planogram incompliance alert when the planogram compliance metric is detected.

3. The method as claimed in claim 1, further comprising:
receiving, by the inventory control system, image data of the product support devices, wherein the image data comprises one or more images of the product support devices;
identifying, by the inventory control system, the plurality of products in the product support devices based on the image data;
determining, by the inventory control system, a product-count corresponding to each of the plurality of products identified; and
determining, by the inventory control system, product stock-out condition, for inventory control, for at least one of the plurality of products by comparing the product-count of the at least one of the plurality of products with a corresponding predefined threshold count, wherein the product stock-out condition indicates at least one of an out of stock condition and low on stock condition.

4. The method as claimed in claim 3, wherein the identifying of the plurality of products based on the image data is performed by:
generating, by the inventory control system, a clean image data by removing noise data from the image data using a filter, wherein the noise data comprises blur and unwanted signals present in the image data;
identifying, by the inventory control system, a region of interest (ROI) in the clean image data, wherein the ROI corresponds to the product support devices;
detecting, by the inventory control system, one or more rows associated with the product support devices based on the ROI and line and color detection technique;
detecting, by the inventory control system, horizontally stacked and vertically stacked products, of the plurality of products, placed on the one or more rows using horizontal line detection technique and vertical line detection technique respectively, wherein each of the plurality of products has corresponding dimension and position; and
identifying, by the inventory control system, each of the plurality of products based on the corresponding dimension and position.

5. The method as claimed in claim 3, wherein the image data is linked with the sensor data for a predefined time-stamp.

6. The method as claimed in claim 3, further comprising generating, by the inventory control system, a stock-out alert when the product-count corresponding to at least one of the plurality of products is less than the corresponding predefined threshold count.

7. The method as claimed in claim 3 further comprising generating, by the inventory control system, a report depicting the product stock-out condition.

8. The method as claimed in claim 1 further comprising generating, by the inventory control system, a report depicting the planogram compliance metric.

9. The method as claimed in claim 3, further comprising:
determining, by the inventory control system, based on the image data and the sensor data, a remaining space in the product support devices; and
generating, by the inventory control system, product filling information for the product support devices based on the product stock-out condition, wherein the product filling information provides a filling-count of the at least one product in the product support devices.

10. The method as claimed in claim 1, wherein the predefined arrangement comprises predefined position of the plurality of products on the product support devices.

11. An inventory control system for inventory control in an establishment, the system comprising:
a processor; and
a memory communicatively coupled to the processor, wherein the memory stores processor-executable instructions, which, on execution, causes the processor to:
receive sensor data associated with a plurality of products and planogram data associated with the establishment, wherein:
the sensor data provides depth-information of the plurality of products placed on product support devices in the establishment supporting the plurality of products, and
the planogram data comprises dimensions and predefined arrangement of the plurality of products placed on the product support devices;
determine current position of the plurality of products based on the sensor data;
compare the current position of the plurality of products with the predefined arrangement as defined in the planogram data; and
determine a planogram compliance metric for inventory control based on the comparison, wherein the planogram compliance metric indicates a deviation of placement of the plurality of products from the predefined arrangement.

12. The inventory control system as claimed in claim 11, wherein the processor is further configured to generate planogram incompliance alert when the planogram compliance metric is detected.

13. The inventory control system as claimed in claim 11, wherein the processor is further configured to:
receive image data of the product support devices, wherein the image data comprises one or more images of the product support devices;
identify the plurality of products in the product support devices based on the image data;
determine a product-count corresponding to each of the plurality of products identified; and
determine product stock-out condition, for inventory control, for at least one of the plurality of products by comparing the product-count of the at least one of the plurality of products with a corresponding predefined threshold count, wherein the product stock-out condition indicates at least one of an out of stock condition and low on stock condition.

14. The inventory control system as claimed in claim 13, wherein the processor identifies the plurality of products based on the image data by:
generating a clean image data by removing noise data from the image data using a filter, wherein the noise data comprises blur and unwanted signals present in the image data;
identifying a region of interest (ROI) in the clean image data, wherein the ROI corresponds to the product support devices;
detecting one or more rows associated with the product support devices based on the ROI and line and color detection technique;
detecting horizontally stacked and vertically stacked products, of the plurality of products, placed on the one or more rows using horizontal line detection technique and vertical line detection technique respectively, wherein each of the plurality of products has corresponding dimension and position; and
identifying each of the plurality of products based on the corresponding dimension and position.

15. The inventory control system as claimed in claim 13, wherein the image data is linked with sensor data for a predefined time-stamp.

16. The inventory control system as claimed in claim 13, wherein the processor is further configured to generate a stock-out alert when the product-count corresponding to at least one of the plurality of products is less than the corresponding predefined threshold count.

17. The inventory control system as claimed in claim 11, wherein the processor is further configured to generate a report depicting the planogram compliance metric.

18. The inventory control system as claimed in claim 13, wherein the processor is further configured to generate a report depicting the product stock-out condition.

19. The inventory control system as claimed in claim 13, wherein the processor is further configured to:
determine, based on the image data and the sensor data, a remaining space in the product support devices; and
generate product filling information for the product support devices based on the product stock-out condition, wherein the product filling information provides a filling-count of the at least one product in the product support devices.

20. A non-transitory computer-readable storage medium including instructions stored thereon that when processed by at least one processor cause an inventory control system to perform operations comprising
receiving sensor data associated with a plurality of products and planogram data associated with the establishment, wherein:
the sensor data provides depth-information of the plurality of products placed on product support devices in the establishment supporting the plurality of products, and
the planogram data comprises dimensions and predefined arrangement of the plurality of products placed on the product support devices;
determining current position of the plurality of products based on the sensor data;
comparing the current position of the plurality of products with the predefined arrangement as defined in the planogram data; and
determining a planogram compliance metric for inventory control based on the comparison, wherein the planogram compliance metric indicates a deviation of placement of the plurality of products from the predefined arrangement.
